(19) United States
(12) Patent Application Publication
(10) Pub. No.: US 2011/0193945 A1
(43) Pub. Date: Aug. 11, 2011

(54) Image display device, image display viewing system and image display method

(75) Inventor: Yuji Tsuchida, Kanagawa (JP)

(73) Assignee: Sony Corporation, Tokyo (JP)

(21) Appl. No.: 12/931,062

(22) Filed: Jan. 24, 2011

(30) Foreign Application Priority Data
Feb. 5, 2010 (JP) P2010-024402

(51) Int. Cl. H04N 13/00

(52) U.S. Cl. 348/51; 348/E13.026

(57) ABSTRACT

An image display device includes an invalid area detecting portion that detects an invalid area of an image for a left eye and an image for a right eye, a final invalid area calculating portion that calculates a final invalid area of the image for the left eye and the image for the right eye based on the detected invalid area and a depth adjustment amount, a mask amount calculating portion that calculates a mask amount based on the final invalid area, a depth adjustment portion that adjusts a depth of a stereoscopic image based on the depth adjustment amount, a mask adding portion that adds a mask to the image for the left eye and to the image for the right eye after the adjustment, and a display portion that displays the image for the left eye and the image for the right eye to each of which the mask is added.

### CROSS-REFERENCE TO RELATED APPLICATION

The present application claims priority from Japanese Patent Application No. JP 2010-024402 filed in the Japanese Patent Office on Feb. 5, 2010, the entire content of which is incorporated herein by reference.

### BACKGROUND OF THE INVENTION

1. Field of the Invention

The present invention relates to an image display device, an image display viewing system and an image display method.

2. Description of the Related Art

Recently, a technology using an image display device to display a stereoscopic image is used. When the stereoscopic image that is displayed by this type of image display device is viewed, a focus adjustment distance becomes different, even though a convergence angle is substantially similar to that of the real world. As a result, this becomes a causal factor of visual fatigue of the viewer. In particular, a burden is placed on the viewer when a change in parallax is large, for example, if a certain area within a screen pops out excessively, or if an object pops out suddenly when a moving image is being displayed.

Therefore, for example, as described in Japanese Patent No. 3978392, a technology is proposed in which a degree of popping out, a sense of depth etc. are adjusted to perform a natural stereoscopic display by setting an offset by which a right image is displaced to a right side or to a left side with respect to a left image.

### SUMMARY OF THE INVENTION

However, when image shifting or scaling is performed by the above-mentioned adjustment processing, a part of left and right edges of an input image may extend outside of a display screen, or an invalid image area may be displayed on a display surface. When this type of invalid image area is viewed in a three-dimensional manner, an image area that forms a pair with the image area concerned (an image for a left eye with respect to an image for a right eye or an image for the right eye with respect to an image for the left eye) becomes an area outside of the screen. Hence, depending on a color, a brightness etc. of the area outside of the screen, a binocular rivalry arises between “a color of the invalid image area” and “the area outside of the screen”, and the user may find it difficult to view a video image.

In light of the foregoing, it is desirable to provide a novel and improved image display device, image display viewing system and image display method that are capable of improving a display quality of a depth-adjusted stereoscopic image.

According to an embodiment of the present invention, there is provided an image display device includes an invalid area detecting portion that detects an invalid area of an image for a left eye and an image for a right eye, the image for the left eye and the image for the right eye being input images, a final invalid area calculating portion that calculates a final invalid area of the image for the left eye and the image for the right eye based on the detected invalid area and a depth adjustment amount, a mask amount calculating portion that calculates a mask amount based on the final invalid area, a depth adjustment portion that adjusts a depth of a stereoscopic image based on the depth adjustment amount, the stereoscopic image being formed by the image for the left eye and the image for the right eye, a mask adding portion that, based on the mask amount, adds a mask to the image for the left eye and to the image for the right eye after the adjustment, and a display portion that displays the image for the left eye and the image for the right eye to each of which the mask is added.

In this configuration, the final invalid area calculating portion calculates the final invalid area by adding a variation amount to the detected invalid area, the variation amount being based on the depth adjustment amount.

In this configuration, the mask amount calculating portion adds the mask amount based on a maximum value of the final invalid area for the image for the left eye and the image for the right eye respectively.

In this configuration, the depth adjustment portion adjusts the depth by performing one of scaling processing and shifting processing on the image for the left eye and on the image for the right eye, respectively.

In this configuration, respective processing by the invalid area detecting portion, the final invalid area calculating portion, the mask amount calculating portion and the mask adding portion is performed on each line of a display screen of the display portion.

According to another embodiment of the present invention, there is provided an image display viewing system includes an image display device and stereoscopic video image viewing glasses. The image display device includes an invalid area detecting portion that detects an invalid area of an image for a left eye and an image for a right eye, the image for the left eye and the image for the right eye being input images, a final invalid area calculating portion that calculates a final invalid area of the image for the left eye and the image for the right eye based on the detected invalid area and a depth adjustment amount, a mask amount calculating portion that calculates a mask amount based on the final invalid area, a depth adjustment portion that adjusts a depth of a stereoscopic image based on the depth adjustment amount, the stereoscopic image being formed by the image for the left eye and the image for the right eye, a mask adding portion that, based on the mask amount, adds a mask respectively to the image for the left eye and the image for the right eye after the adjustment, and a display portion that displays the image for the left eye and the image for the right eye to each of which the mask is added. The stereoscopic video image viewing glasses have shutters for the right eye and for the left eye, and that open and close the shutters for the right eye and for the left eye in accordance with switching between the image for the right eye and the image for the left eye on the display portion.

According to another embodiment of the present invention, there is provided an image display method, includes the steps of detecting an invalid area of an image for a left eye and an image for a right eye, the image for the left eye and the image for the right eye being input images, calculating a final invalid area of the image for the left eye and the image for the right eye based on the detected invalid area and a depth adjustment amount, calculating a mask amount based on the final invalid area, adjusting a depth of a stereoscopic image based on the depth adjustment amount, the stereoscopic image being formed by the image for the left eye and the image for the right eye, adding a mask, based on the mask amount, to the image for the left eye and to the image for the right eye after the adjustment, and displaying the image for the left eye and the image for the right eye to each of which the mask is added.

According to the present invention, it is possible to provide an image display device, image display viewing system and image display method that are capable of improving a display quality of a depth-adjusted stereoscopic image.

### BRIEF DESCRIPTION OF THE DRAWINGS

FIG. 1 is a schematic diagram showing convergence angles α, β and γ that are formed by directions of a right eye and a left eye of a viewer when, with respect to a location of a display surface, a video image is seen at a location farther than the display surface and a video image is seen at a location closer than the display surface;

FIG. 2 is a schematic diagram showing an example of shifting left and right images in opposite directions as a depth adjustment method of a three-dimensional image;

FIG. 3 is a schematic diagram showing an example of scaling (expanding and reducing) the left and right images in a horizontal direction as a depth adjustment method of the three-dimensional image;

FIG. 4 is a block diagram showing a configuration of an image display device 100 according to a present embodiment;

FIG. 5 is a schematic diagram showing an input image to which rectangular invalid areas are added;

FIG. 6 is a schematic diagram showing invalid image area widths TWLL, TWLR, TWRL and TWRR;

FIG. 7 is a schematic diagram showing optimum mask widths ML and MR;

FIG. 8 is a schematic diagram showing an example in which invalid area widths WLL, WLR, WRL and WRR are added respectively on every n lines;

FIG. 9 is a schematic diagram showing an example in which the invalid image area widths TWLL, TWLR, TWRL and TWRR are added respectively on every n lines;

FIG. 10 is a schematic diagram showing an example in which the optimum mask widths ML and MR are added respectively on every n lines;

FIG. 11 is a diagram illustrating an effect of mask processing according to the present embodiment;

FIG. 12 is a schematic diagram showing a configuration of a stereoscopic image display viewing system according to the present embodiment of the invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that a description will be made below in the following order.

1. Prerequisite Technology

2. Configuration Example of Image Display Device According to Present Embodiment

3. Example of Adding Mask to Every Line

4. Configuration Example of Stereoscopic Image Display Viewing System

### 1. Prerequisite Technology

At present, most video image materials produced for three-dimensional movies are produced on the assumption that the video image materials will be viewed at a movie theatre. Since a ratio of an interorbital distance of the viewer with respect to a screen size is smaller in the movie theatre than in a three-dimensional viewing environment for a household, it is possible to generate a large pop-out effect or pushed-back effect in the movie theatre by displacing left and right images only slightly (full screen size ratio), when the movie theatre and the household environment are compared assuming that their viewing angles with respect to screen edges are substantially similar.

When this type of video image material is viewed on a household three-dimensional television as it is, a stereoscopic effect becomes insufficient despite an intention of the movie production. Therefore, when the movie materials are converted to household-use three-dimensional content, such as blueray discs (BD), it is assumed that, in order to make up for the lack of the stereoscopic effect, “manual dynamic depth adjustment” is performed according to scenes in a process of authoring. Note that this type of dynamic depth adjustment may also be performed in a similar manner on the movie materials produced for the movie theater. Further, it is assumed that the “manual dynamic depth adjustment” may be performed not only for the movie, but also actively performed in postproduction, in order to produce the stereoscopic effect.

However, due to a difference of a viewing environment between a producer side and a viewer side and also due to differences in eyesight, preferences etc. of the producer and the viewer, a video image after the adjustment is not necessarily adjusted to an appropriate parallax of both eyes for the viewer. For example, when content that has been adjusted on the producer side using a 40-inch monitor with a viewing distance of 1.5 m is viewed by the viewer using a 60-inch monitor with the viewing distance of 1.5 m, the stereoscopic effect (sense of back and front perspective) is highlighted more in the viewing environment of the viewer than in the viewing environment of the producer. Note that the stereoscopic effect and the sense of back and front perspective are defined as a dynamic range of a distance up to a virtual image of each object that is seen at a location of a convergence point, and in particular, when a difference in a distance between two objects is described, it is expressed as the “sense of back and front perspective”.

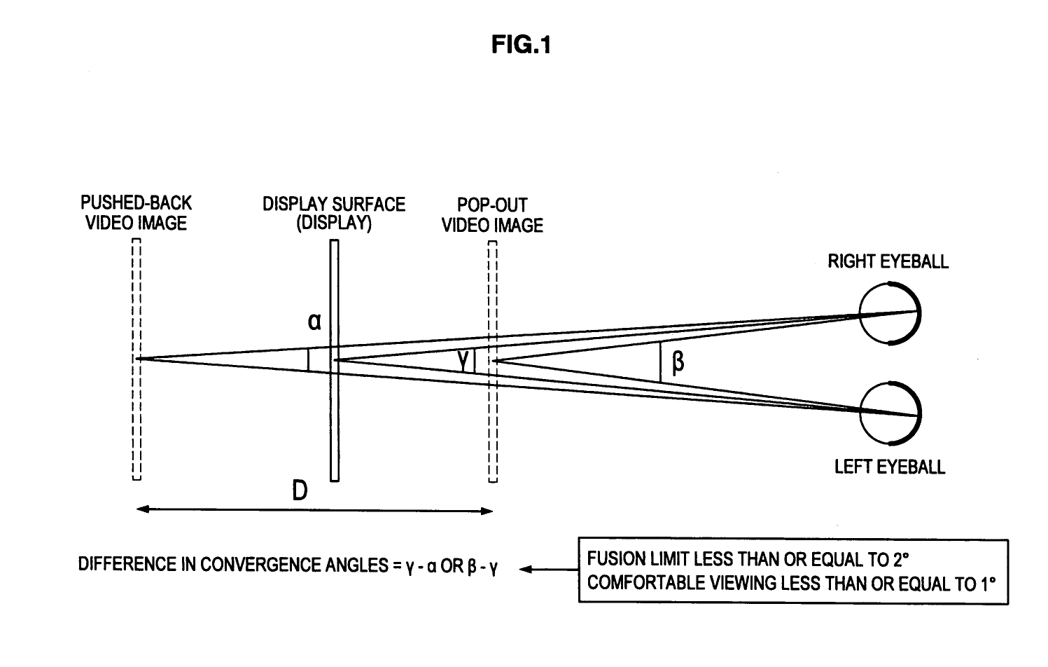

Therefore, if the video image after the adjustment is not adjusted appropriately for the viewer, it is possible that some problems may arise. For example, an image at a distant point may not be fusionally displayed when a convergence angle becomes less than 0°, which exceeds a divergence limit of the viewer, or an image at a near point may not be fusionally displayed when a degree of pop-out is too large. Further, it may become difficult to fusionally display an image when an inconsistency between a focus adjustment distance and the convergence angle of the viewer's eyeballs becomes too large and the viewer may become prone to tiredness etc. FIG. 1 is a schematic diagram showing convergence angles α, β and γ that are formed by directions of a right eye and a left eye of a viewer when, with respect to a location of a display surface, a video image is seen at a location farther than the display surface and a video image is seen at a location closer than the display surface. As shown in FIG. 1, a comparative size relationship of the convergence angles α, β and γ is α<γ<β. Although a human brain judges a distance using the convergence angle, if the convergence angle changes significantly, situations arise in which an image is not fusionally displayed, as described above. Further, even when the image is fusionally displayed, if the convergence angle changes significantly, the viewer's eyes may get tired easily. In general, in order to cause the images at the distant point and the near point to be fusionally displayed, as shown in FIG. 1, it is preferable to keep a difference between a maximum convergence angle and a minimum convergence angle, namely γ−α or β−γ, less than or equal to 2°, the difference of the convergence angle being considered as a difference in parallax. Further, in order to realize comfortable viewing, in which the viewer's eyes do not get tired easily, it is preferable to keep γ−α or β−γ less than or equal to 1°.

Given these actual conditions, when the three-dimensional content is provided by a broadcasting station, it is assumed that depth adjustment is performed on an original image captured through filming by parallel shifting the image or expanding or reducing the image. Further, as a depth amount of the video image is sensed by each viewer differently, it is assumed that a “depth adjustment function” is performed by shifting the image (shift) or expanding or reducing the image (scaling), as a function provided on a display device side. Note that, with respect to the depth adjustment, the applicant has already filed a patent application (Japan Patent Application No. 2009-199139).

In either case, in which the “depth adjustment function” is performed by the broadcasting station or “manual or automatic dynamic depth adjustment” is performed by the display device, depth adjustment processing is performed by shifting the left and right images in opposite directions respectively or by scaling the left and right images at a substantially similar expansion or reduction rate.

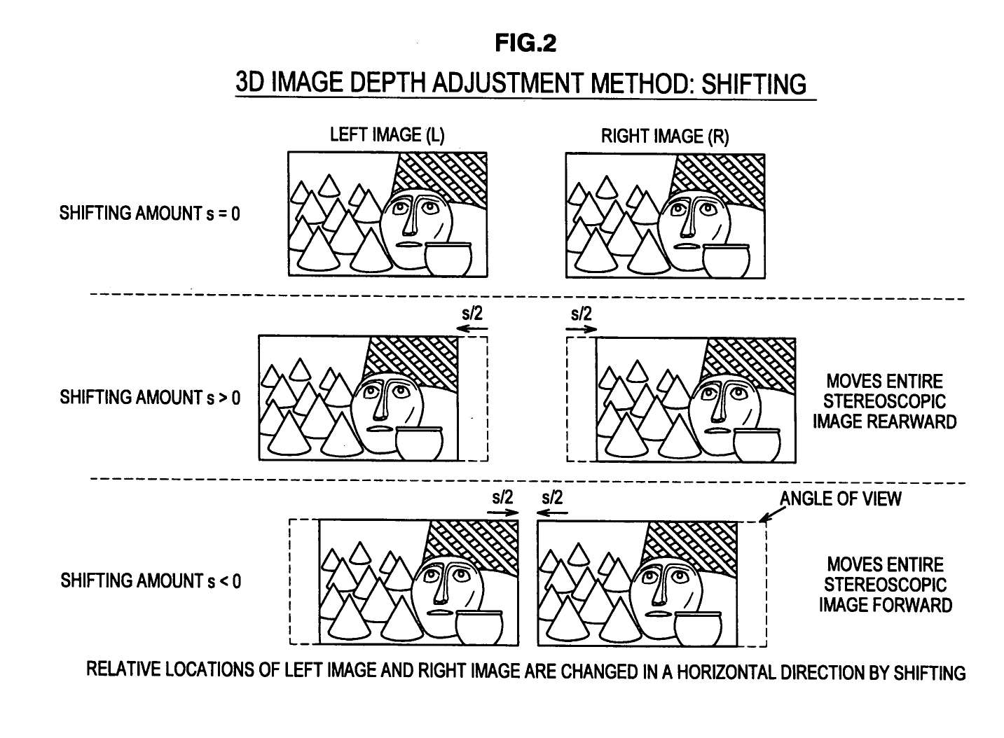

FIG. 2 is a schematic diagram showing an example of shifting the left and right images in opposite directions as a depth adjustment method of the three-dimensional image. When a shift amount of the original image is defined as 0 and a shift amount as s, in a case where s>0, an image L for the left eye is shifted by s/2 to the left and an image R for the right eye is shifted by s/2 to the right. In this manner, the three-dimensional image as a whole can be shifted in a rearward direction (in a direction toward the back of the display from the viewer's point of view) almost without changing a distance D (refer to FIG. 1), the distance D being an apparent distance between the pop-out video image and the pushed-back video image. On the other hand, in a case where s<0, the image L for the left eye is shifted by s/2 to the right and the image R for the right eye is shifted by s/2 to the left. In this manner, the three-dimensional image as a whole can be shifted in a forward direction (in a direction toward the front of the display from the viewer's point of view) almost without changing the distance D (refer to FIG. 1), the distance D being the apparent distance between the pop-out video image and the pushed-back video image.

In this way, when the image for the right eye is parallel shifted in the rightward direction and the image for the left eye is parallel shifted in the leftward direction, the three-dimensional image as a whole can be shifted in the direction toward the back of the screen. Further, when the image for the right eye is parallel shifted in the leftward direction and the image for the left eye is parallel shifted in the rightward direction, the three-dimensional image as a whole can be shifted in the direction toward the front of the screen.

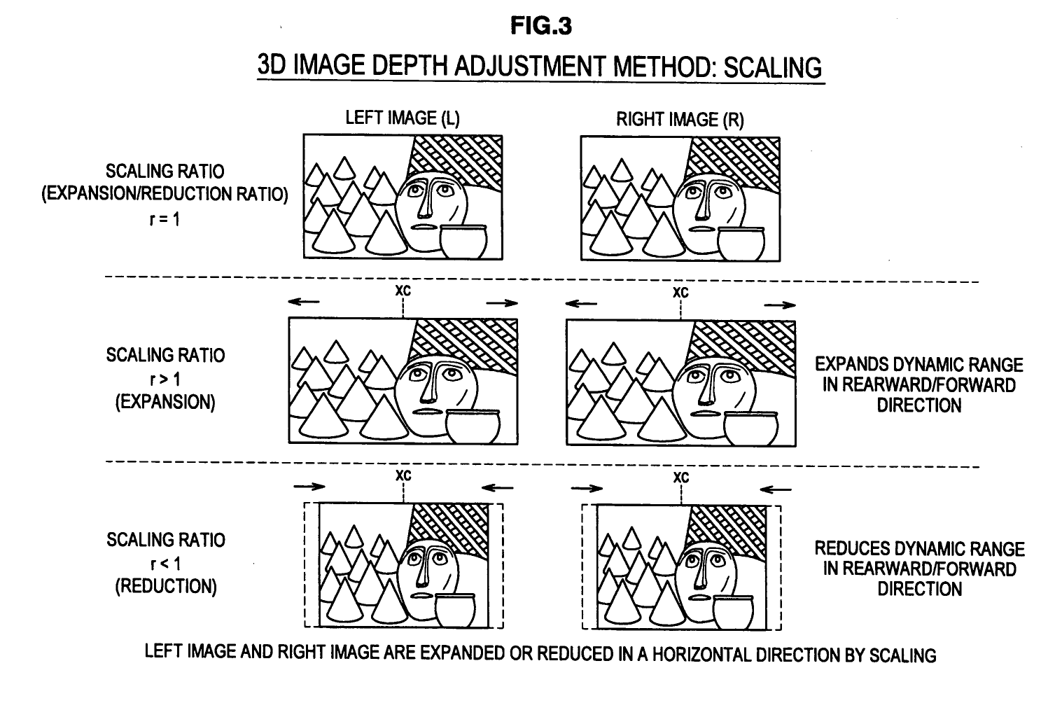

FIG. 3 is a schematic diagram showing an example of scaling (expanding and reducing) the left and right images in a horizontal direction as the depth adjustment method of the three-dimensional image. When an expansion/reduction rate r of the original image is regarded as 1, in a case where r>1, the left and right images are expanded in the horizontal direction while having a central coordinate xc in the horizontal direction located at the center. In this way, the apparent distance D between the pop-out video image and the pushed-back video image (refer to FIG. 1) can be extended, and the dynamic range of the three-dimensional image can be expanded. On the other hand, in a case where r<1, the left and right images are reduced in the horizontal direction while having the central coordinate xc in the horizontal direction located at the center. In this way, the apparent distance D between the pop-out video image and the pushed-back video image (refer to FIG. 1) can be shortened, and the dynamic range of the three-dimensional image can be reduced. Note that, although FIG. 3 only shows how scaling processing in the horizontal direction is performed for an illustrative purpose, in practice, scaling processing in the vertical direction is also performed to maintain a similar aspect ratio.

In this way, when the image is reduced, a gap between the farthest point and the nearest point of the three-dimensional image is narrowed while having the display surface at the center, and a sense of depth is compressed. On the contrary, when the image is expanded, the gap between the farthest point and the nearest point of the three-dimensional image is widened while having the display surface at the center, and the sense of depth is extended. Note that the sense of depth indicates a degree of how much deeper the virtual image is seen compared with an actual screen. The term “depth” is conventionally used for the three-dimensional video image in particular, but the expression “sense of depth” is also applied to the pop-out video image. In either case, the term and the expression do not refer to specific objects, but to an average location of the full screen.

Note that the shifting and scaling processing is not necessarily performed for the entire image using similar parameters, but different amounts of parallel shifting or expansion/reduction rates may be applied to different areas of the image.

On the other hand, when the shifting or scaling of the image is performed using the depth adjustment processing, a part of left and right edges of an input image may extend beyond a display screen, or an invalid image area may be displayed on the display surface.

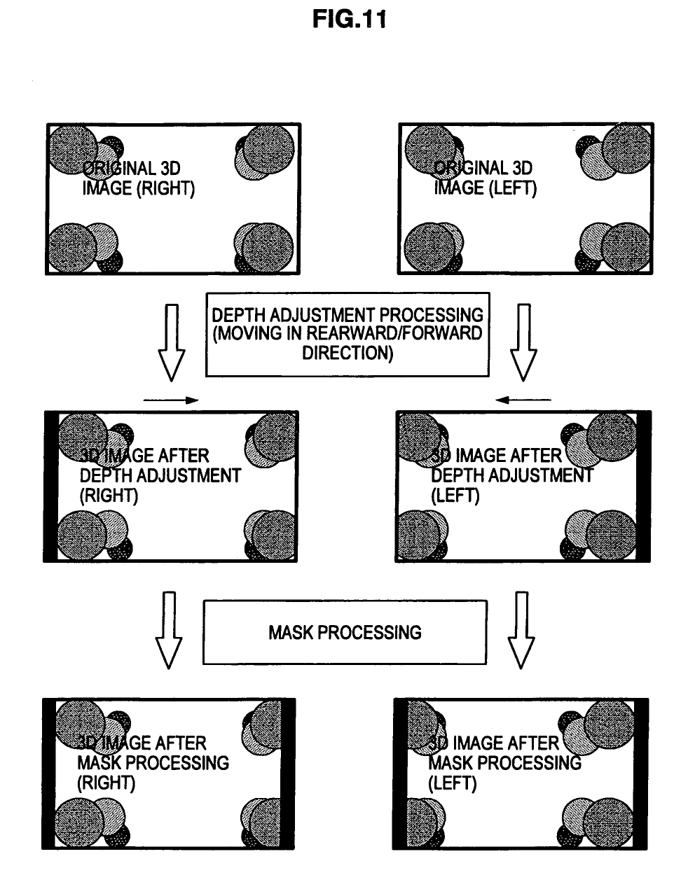

Further, in either case in which the “manual dynamic depth adjustment” is performed on a content provider side or the “depth adjustment function” is performed on the display device side, an amount of depth adjustment may be controlled adaptively based on the scenes, and an overhang width or a width of the invalid image area constantly changes based on the scenes. When this type of invalid image area is viewed in a three-dimensional manner, the image area that forms a pair with the image area concerned (the image for the left eye with respect to the image for the right eye or the image for the right eye with respect to the image for the left eye) becomes the area outside the screen (in the case of a television, an area covered by a casing frame located outside the display screen). Figures shown in a middle section of FIG. 11 show that no image area exists that forms a pair with a depth-adjusted image for the left eye and a depth-adjusted image for the right eye. Hence, depending on a color or brightness outside the screen, binocular rivalry may occur between a “color of the invalid image area” and a “color of the casing frame etc. outside the screen”, and the user may find it difficult to view the video image.

Therefore, the present embodiment is designed to reliably inhibit the binocular rivalry that arises as a result of the depth adjustment. Here, there are methods for resolving the binocular rivalry, such as performing overscan and preventing the invalid image area from being displayed on the screen, or adding a mask and turning the image area that forms a pair with the invalid image area into an invalid image area as well. However, in either method, if a setting value of a processing amount, namely, an overscan amount or a mask amount, is too large, valid image information is removed to an extent more than necessary. On the other hand, if the processing amount is too small, an effect of inhibiting the binocular rivalry may not be sufficiently obtained.

### 2. Configuration Example of Image Display Device According to Present Embodiment

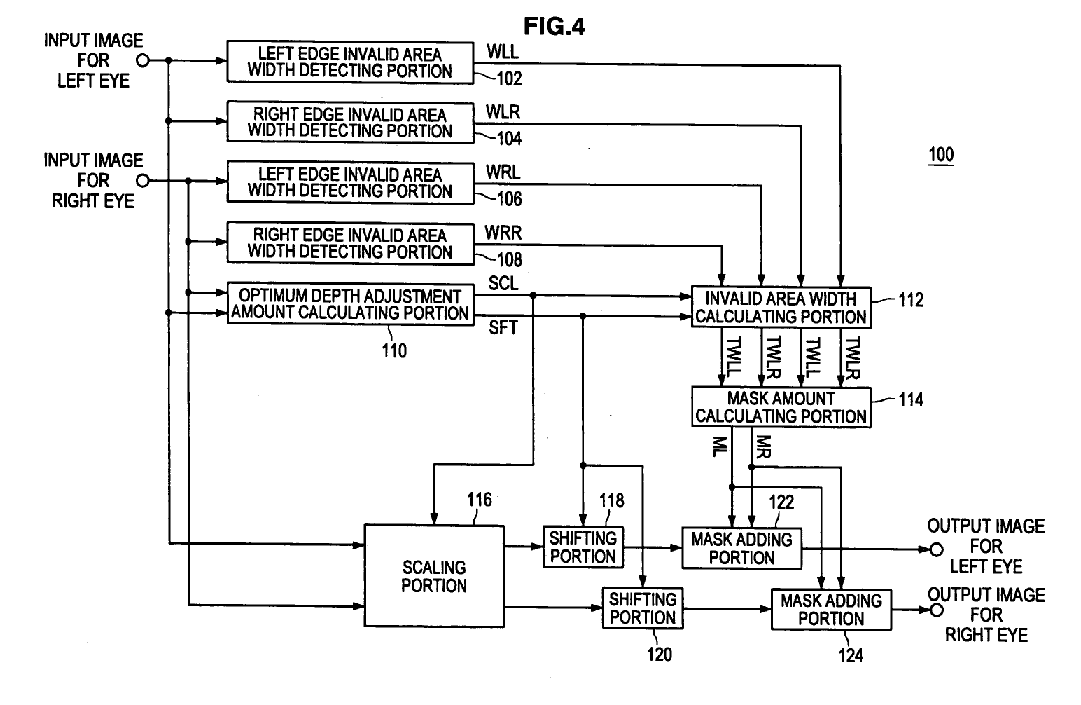

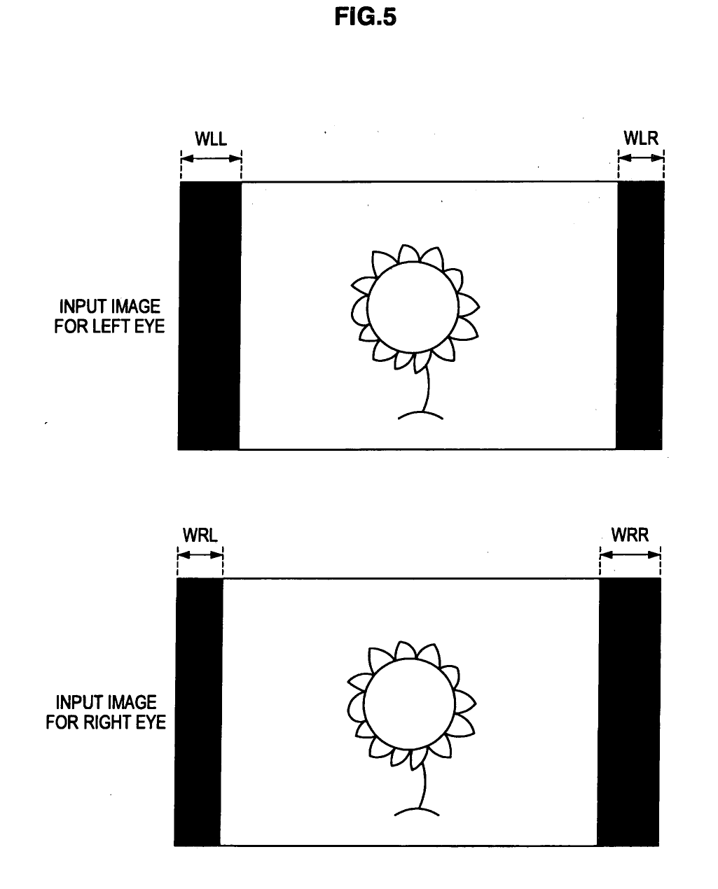

Therefore, in the present embodiment, a minimum mask that can reliably inhibit the binocular rivalry is added. FIG. 4 is a block diagram showing a configuration of an image display device 100 according to the present embodiment. A detailed processing procedure will be explained below using as an example an input image, to which a rectangular invalid area is added as shown in FIG. 5. With respect to the input image shown in FIG. 5, as a result of the depth adjustment processing performed on the input image on the content provider side, the invalid area is added to left and right edges of an input image for the left eye and an input image for the right eye respectively. In the invalid area, luminance has a minimum value, and a black image is displayed in the area.

As shown in FIG. 4, the image display device 100 is provided with a left edge invalid area width detecting portion 102 and a right edge invalid area detecting portion 104 into which the input image for the left eye is input. Further, the image display device 100 is provided with a left edge invalid area width detecting portion 106 and a right edge invalid area detecting portion 108 into which the input image for the right eye is input. In addition, the image display device 100 is provided with an optimum depth adjustment amount calculating portion 110, an invalid area width calculating portion 112, a mask amount calculating portion 114, a scaling portion 116, shifting portions 118 and 120, and mask adding portions 122 and 124. Note that each block shown in FIG. 4 can be structured with a circuit (hardware) or a central processing unit (CPU) and a program (software) that causes the circuit or the CPU to function. In this case, the program can be stored in a memory provided in the image display device 100 or in a recording medium such as an external memory.

The left edge invalid area detecting portion 102 detects a left edge invalid area width WLL (shown in FIG. 5) from the input image for the left eye. The right edge invalid area detecting portion 104 detects a right edge invalid area width WLR (also shown in FIG. 5) from the input image for the left eye.

In a similar manner, the left edge invalid area detecting portion 106 detects a left edge invalid area width WRL (shown in FIG. 5) from the input image for the right eye. The right edge invalid area detecting portion 108 detects a right edge invalid area width WRR (also shown in FIG. 5) from the input image for the right eye.

Detection of the invalid area width is performed by detecting an area that continues to exist from the left edge to the right edge and in which a signal level stays within a constant range, for example.

As described above, in some cases, the depth adjustment has already been performed on the input image for the left eye and the input image for the right eye that are transmitted from the content provider side. However, further depth adjustment may be performed on the images on the image display device 100 side. The optimum depth adjustment amount calculating portion 110 calculates a depth adjustment processing parameters for the depth adjustment processing performed on the image display device 100 side. The depth adjustment processing parameters are calculated to absorb differences in the viewing environment between the producer side and the viewer side, or differences in fusion capability and preferences between the producer and the viewer etc. The depth adjustment processing parameters may be calculated based on information which is input by a user using a remote controller etc. or may be automatically calculated based on information relating to content of the video image etc. In a case of automatic calculation, for example, the parallax for each block is obtained by calculating a block correlation for each of a constant block size between the input image for the right eye and the input image for the left eye and by finding out the shift amount in which the correlation becomes highest. Based on a result of this calculation, a variation range of the parallax in the viewing environment is obtained, and a scaling amount SCL and a shifting amount SFT are calculated such that the variation range falls within an appropriate range. With respect to the scaling amount SCL and the shifting amount SFT, besides using the calculated values, the viewer may correct the values by him/herself or, in place of the detected values, values may be used that are directly input by the viewer.

In the scaling portion 116, based on the scaling amount SCL calculated by the optimum depth adjustment amount calculating portion 110, the scaling processing as illustrated in FIG. 3 is performed on left and right input image signals. Note that a reference location of the scaling is the center of the screen in the horizontal direction. Further, in the shifting portion 118, based on the shifting amount SFT calculated by the optimum depth adjustment amount calculating portion 110, the shifting processing as illustrated in FIG. 2 is performed on the input image for the right eye. In a similar manner, in the shifting portion 120, based on the shifting amount SFT calculated in the optimum depth adjustment amount calculating portion 110, the shifting processing as illustrated in FIG. 2 is performed on the input image for the left eye. Note that a unit of the shifting amount SFT is a number of pixels. In this way, the depth adjustment is performed further on the image display device 100 side with respect to the input image on which the depth adjustment has already been performed on the content provider side.

In the invalid area width calculating portion 112, the invalid image area width is obtained that appears on the display surface after the depth adjustment is performed on the image display device 100 side. In the invalid area width calculating portion 112, based on the above-described WLL, WLR, WRL, WRR, SCL and SFT, invalid image area widths TWLL, TWLR, TWRL and TWRR, which are displayed on a final output image, are calculated using expressions described below.

TWLL=1920/2−SCL×(1920/2−WLL)−SFT

TWLR=1920/2−SCL×(1920/2−WLR)+SFT

TWRL=1920/2−SCL×(1920/2−WRL)+SFT

TWRR=1920/2−SCL×(1920/2−WRR)−SFT

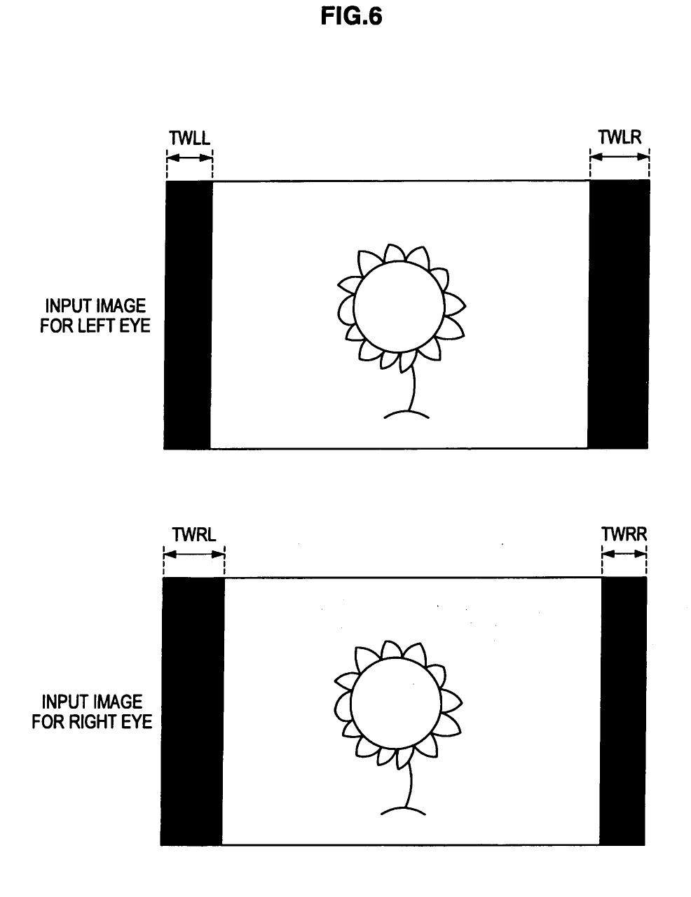

FIG. 6 is a schematic diagram showing the invalid image area widths TWLL, TWLR, TWRL and TWRR. As shown in FIG. 6, TWLL is the left edge invalid area width for the input image for the left eye and TWLR is the right edge invalid area width for the input image for the left eye on which the depth adjustment has already been performed on both the content provider side and the image display device 100 side. Further, TWRL is the left edge invalid area width for the input image for the right eye and TWRR is the right edge invalid area width for the input image for the right eye on which the depth adjustment has already been performed on both the content provider side and the image display device 100 side.

Here, a unit of TWLL, TWLR, TWRL and TWRR is a number of pixels. Note that the expressions described above are based on a case in which a screen resolution in the horizontal direction is 1920 pixels, and when they are applied to a general case, 1920 should be replaced with a horizontal resolution of the display surface. Note also that a calculated value is an integer value rounded up to the closest integer value above, such that the invalid image area width is calculated to be bigger rather than smaller.

Next, in the mask amount calculating portion 114, optimum mask widths ML and MR are calculated from the calculated invalid image area widths TWLL, TWLR, TWRL and TWRR using expressions described below.

ML=MAX (TWLL, TWRL)

MR=MAX (TWLR, TWRR)

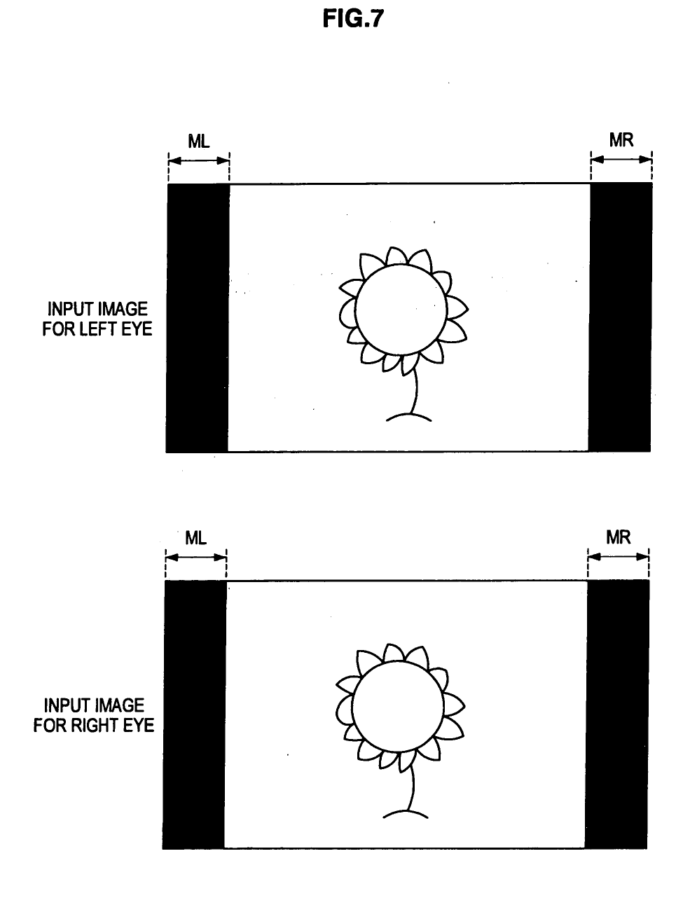

FIG. 7 is a schematic diagram showing the optimum mask widths ML and MR. Base on the above-described expressions, with respect to the input image for the left eye and the input image for the right eye respectively, either TWLL or TWRL, whichever is a bigger value, is considered to be the optimum mask amount ML and either TWLR or TWRR, whichever is a bigger value, is considered to be the optimum mask amount MR. In this way, it is possible to add a minimum mask having a substantially similar width to the input image for the left eye and the input image for the right eye respectively.

In the mask adding portion 122, with respect to the input image for the left eye on which the scaling and shifting processing has been performed, the mask of ML pixels is added to the left edge of the image and the mask of MR pixels is added to the right edge of the image. In the mask adding portion 124, with respect to the input image for the right eye on which the scaling and shifting processing has been performed, the mask of ML pixels is added to the left edge of the image and the mask of MR pixels is added to the right edge of the image.

With respect to a luminance level of the masks that are added in the mask adding portions 122 and 124, a luminance value is preferably set to 0. This is because, since an illuminance level around the display surface is lower when a level of ambient light (a fluorescent light in a room etc.) is low, the mask sections ML and MR are blended into a peripheral environment and become inconspicuous in that state, thus inhibiting binocular rivalry.

### 3. Example of Adding Mask to Every Line

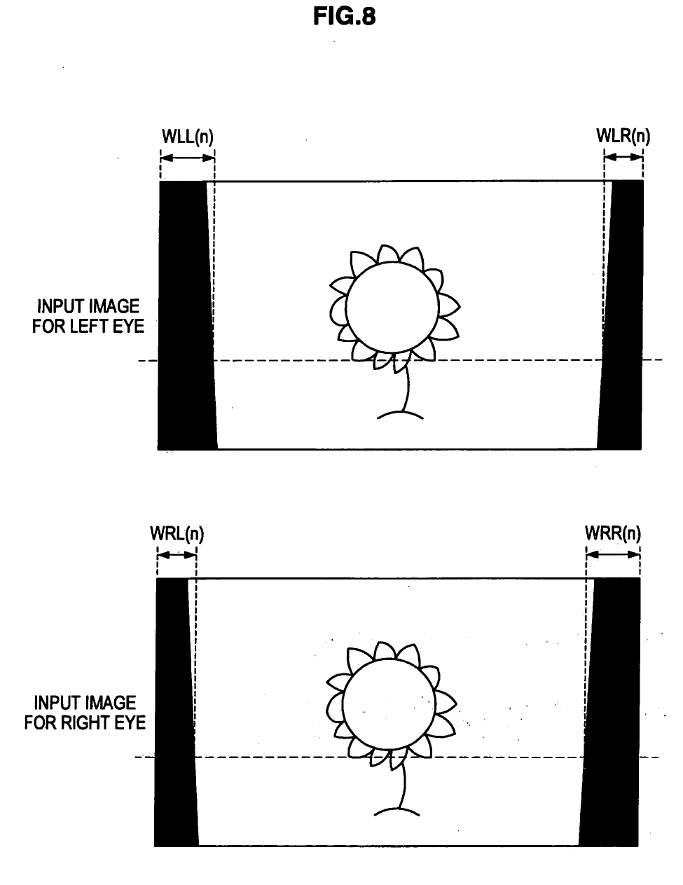

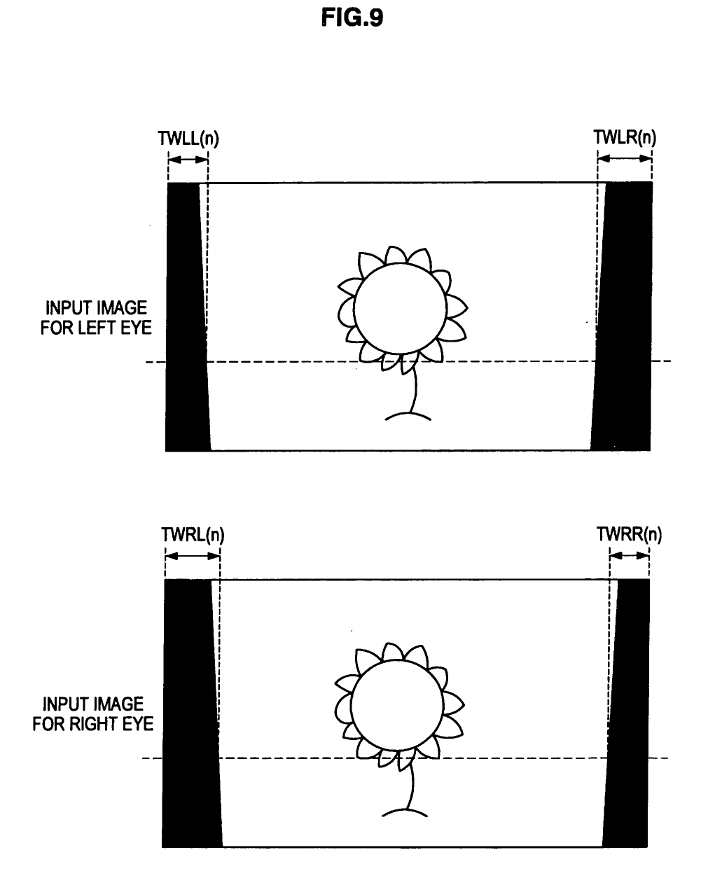

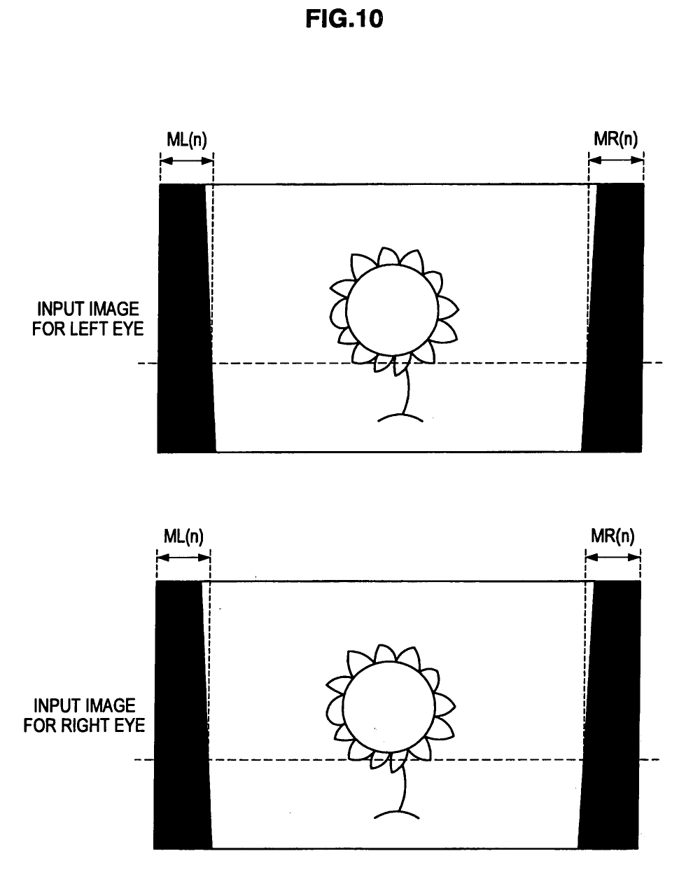

FIG. 8 to FIG. 10 are schematic diagrams showing examples in which the invalid area widths WLL, WLR, WRL and WRR, the invalid image area widths TWLL, TWLR, TWRL and TWRR, and the optimum mask amounts ML and MR, all of which are described above, are added respectively every n lines. In this case, the invalid image area having a chosen shape is added by changing an area width for each line. In this case, as shown in FIG. 8, invalid image area widths WLL (n), WLR (n), WRL (n) and WRR (n) are detected every n lines. Further, as shown in FIG. 9, invalid image area widths TWLL (n), TWLR (n), TWRL (n) and TWRR (n) are calculated every n lines. Then, as shown in FIG. 10, by calculating optimum mask amounts ML (n) and MR (n) every line and performing mask processing on every line, it becomes possible to minimize reduction of a valid image area while also inhibiting binocular rivalry.

FIG. 11 is a diagram illustrating an effect of the mask processing according to the present embodiment. FIG. 11 is a diagram that can be viewed in a stereoscopic manner using an intersection method. The post-depth adjustment processing images shown in the middle section of FIG. 11 are images on which the depth adjustment processing has already been performed on the image display device 100 side and to which the mask adding portions 122 and 124 have not yet added the masks. When the images after the depth adjustment processing are viewed in the stereoscopic manner, as shown in the middle section of FIG. 11, binocular rivalry occurs between the “black” mask sections and a “white” background at the left and right edges of the screen, since “image areas forming a pair” do not exist in the left and right images. When the mask processing is performed on the images as shown in the bottom section of FIG. 11, binocular rivalry occurring at both edges of the screen is inhibited.

Note that even though the mask is used to inhibit binocular rivalry in the above explanation, overscan processing may be performed instead of the mask processing, such that areas causing binocular rivalry are placed outside the screen.

### 4. Configuration Example of Stereoscopic Image Display Viewing System

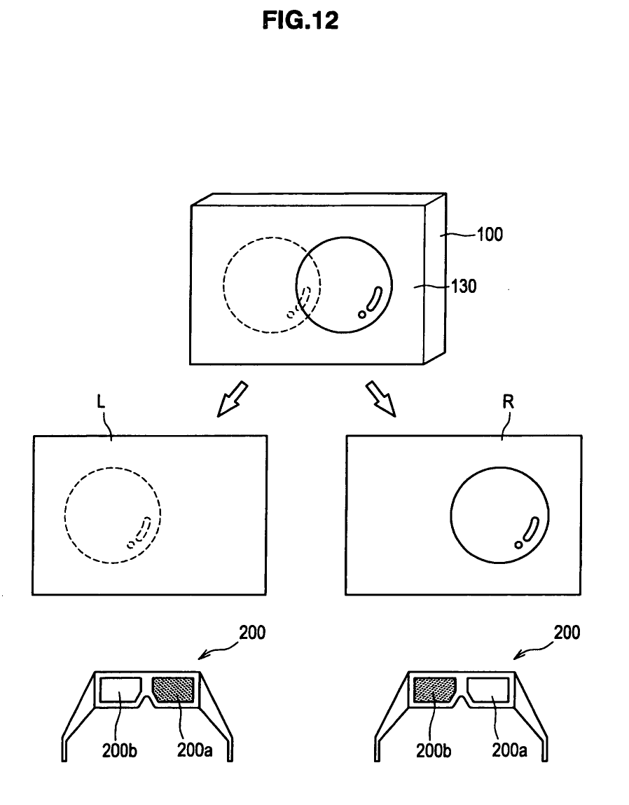

FIG. 12 is a schematic diagram showing a configuration of a stereoscopic image display viewing system according to the present embodiment of the invention. As shown in FIG. 12, the system according to the present embodiment is provided with the above-mentioned image display device 100 and displayed image viewing glasses 200.

The image display device 100 is, for example, a time-division type stereoscopic video image display device and alternately displays the video image for the left eye and the video image for the right eye on a full screen of a display portion 130 at very short intervals, the video image for the left eye and the video image for the right eye being output from the mask adding portions 122 and 124. Further, the image display device 100 separates the video image and provides it for the left eye and the right eye respectively in synchronization with a display interval of the video image for the left eye and the video image for the right eye. The image display device 100 alternately displays a parallax image for the right eye (image R for the right eye) and a parallax image for the left eye (image L for the left eye) in each field, for example. The displayed image viewing glasses 200 are provided with a pair of liquid crystal shutters 200a and 200b that are disposed at locations corresponding to lenses.

The image display device 100 includes an infrared light transmitting portion that transmits an infrared signal in synchronization with display switching between the video image L for the left eye and the video image R for the right eye, and the viewing glasses 200 include an infrared light receiving portion. Based on the received infrared signal, the liquid crystal shutters 200a and 200b perform opening and closing operations alternately in synchronization with image switching performed every field in the image display device 100. Namely, in a field in which the image R for the right eye is displayed on the image display device 100, the liquid crystal shutter 200b for the left eye is set to a closed state, and the liquid crystal shutter 200a for the right eye is set to an open state. Further, in a field in which the image L for the left eye is displayed, an opposite operation to the above-described operation is performed. In this way, the image display device 100 alternately displays the video image for the left eye L and the video image for the right eye R on the full screen at very short intervals, and simultaneously the image display device 100 separates the video image and provides it for the left eye and the right eye respectively in synchronization with the display interval of the video image for the left eye L and the video image for the right eye R.

By performing the above-described operations, only the image R for the right eye is incident to the right eye of the user who watches the image display device 100 wearing the viewing glasses 200, and only the image L for the left eye is incident to the left eye of the user. In this way, the user can recognize the above-mentioned stereoscopic video image through the effect of monocular stereopsis.

The exemplary embodiments of the present invention are described in detail above with reference to the appended drawings. However, the present invention is not limited to the above-described examples. It should be understood by those skilled in the art that various modifications, combinations, sub-combinations and alterations may occur depending on design requirements and other factors insofar as they are within the scope of the appended claims or the equivalents thereof.

What is claimed is:

1. An image display device comprising:
an invalid area detecting portion that detects an invalid area of an image for a left eye and an image for a right eye, the image for the left eye and the image for the right eye being input images;
a final invalid area calculating portion that calculates a final invalid area of the image for the left eye and the image for the right eye based on the detected invalid area and a depth adjustment amount;
a mask amount calculating portion that calculates a mask amount based on the final invalid area;
a depth adjustment portion that adjusts a depth of a stereoscopic image based on the depth adjustment amount, the stereoscopic image being formed by the image for the left eye and the image for the right eye;
a mask adding portion that, based on the mask amount, adds a mask to the image for the left eye and to the image for the right eye after the adjustment; and
a display portion that displays the image for the left eye and the image for the right eye to each of which the mask is added.

2. The image display device according to claim 1,
wherein the final invalid area calculating portion calculates the final invalid area by adding a variation amount to the detected invalid area, the variation amount being based on the depth adjustment amount.

3. The image display device according to claim 1,
wherein the mask amount calculating portion adds the mask amount based on a maximum value of the final invalid area for the image for the left eye and the image for the right eye respectively.

4. The image display device according to claim 1,
wherein the depth adjustment portion adjusts the depth by performing one of scaling processing and shifting processing on the image for the left eye and on the image for the right eye, respectively.

5. The image display device according to claim 1,
wherein respective processing by the invalid area detecting portion, the final invalid area calculating portion, the mask amount calculating portion and the mask adding portion is performed on each line of a display screen of the display portion.

6. An image display viewing system comprising:
an image display device including
an invalid area detecting portion that detects an invalid area of an image for a left eye and an image for a right eye, the image for the left eye and the image for the right eye being input images,
a final invalid area calculating portion that calculates a final invalid area of the image for the left eye and the image for the right eye based on the detected invalid area and a depth adjustment amount,
a mask amount calculating portion that calculates a mask amount based on the final invalid area,
a depth adjustment portion that adjusts a depth of a stereoscopic image based on the depth adjustment amount, the stereoscopic image being formed by the image for the left eye and the image for the right eye,
a mask adding portion that, based on the mask amount, adds a mask respectively to the image for the left eye and the image for the right eye after the adjustment, and
a display portion that displays the image for the left eye and the image for the right eye to each of which the mask is added; and
stereoscopic video image viewing glasses that have shutters for the right eye and for the left eye, and that open and close the shutters for the right eye and for the left eye in accordance with switching between the image for the right eye and the image for the left eye on the display portion.

7. An image display method, comprising the steps of:
detecting an invalid area of an image for a left eye and an image for a right eye, the image for the left eye and the image for the right eye being input images;
calculating a final invalid area of the image for the left eye and the image for the right eye based on the detected invalid area and a depth adjustment amount;
calculating a mask amount based on the final invalid area;
adjusting a depth of a stereoscopic image based on the depth adjustment amount, the stereoscopic image being formed by the image for the left eye and the image for the right eye;
adding a mask, based on the mask amount, to the image for the left eye and to the image for the right eye after the adjustment; and
displaying the image for the left eye and the image for the right eye to each of which the mask is added.
